(19) United States
(12) Patent Application Publication
(10) Pub. No.: US 2025/0378431 A1
(43) Pub. Date: Dec. 11, 2025

(54) Weigh Platter with Power Storage

(71) Applicant: ZEBRA TECHNOLOGIES CORPORATION, Lincolnshire, IL (US)

(72) Inventors: Darran Michael Handshaw, Sound Beach, NY (US); Edward Barkan, Miller Place, NY (US); Mark Drzymala, Saint James, NY (US)

(21) Appl. No.: 18/737,949

(22) Filed: Jun. 8, 2024

(51) Int. Cl. G06Q 20/20; G01G 19/413

(52) U.S. Cl. CPC G06Q 20/208; G01G 19/413

(57) ABSTRACT

The present disclosure describes various embodiments directed at a weighing device with a power supply method for components within the weigh platter. It solves the issue of traditional electrical supply methods interfering with weight measurements by embedding an energy storage assembly within the weigh platter. This assembly supplies power to embedded subsystems when needed and recharges when possible, ensuring efficient power supply without disturbing the weighing process. The power transfer can be selectively controlled based on the weight detected or the reader's operational state. The device can be used in various configurations, extending beyond scales with data capture assemblies.

### BACKGROUND

Stationary indicia readers are commonplace in the retail industry. Those which are provided in a multi-planar (or otherwise known as bi-optic) form factor generally comprise a lower base portion and a raised tower portion. In many implementations the base portion doubles as a scale with a weigh platter forming the top of the base portion. In practice, produce is typically placed on this platter and the weight of the produce is recorded for further transaction processing.

Whether used in connection with a single-plane or a multi-plane configuration, the platter is normally a passive element that is not powered. Inventors have identified that in certain instances it may be beneficial to provide power and/or communications directly to the platter for various reasons, such as the provision of scanner upgrade module cameras, end of platter vision cameras, off-platter detection systems, user indicators located in the platter, in platter wakeup systems, in-platter displays, etc. Accordingly, there is a need for improved designs directed to achieving such functionality.

### SUMMARY

Accordingly, at least some embodiments of the present invention are directed to addressing the problems laid out above.

In an embodiment, the present invention is an indicia reader comprising: a housing having a lower housing portion with an upper surface facing a product scanning region and an upper housing portion extending above the lower housing portion; a power source assembly positioned at least partially within the housing; a load cell; and a weigh platter configured to be supported by the load cell, the weigh platter further configured to support an object placed on the weigh platter for obtaining a weight of the object, the weigh platter having a power storage assembly, wherein the power source assembly is configured to supply electrical power to the power storage assembly resulting in stored electrical power, and wherein the power storage assembly is configured to deliver the stored electrical power to at least one electronic device within the weigh platter.

In another embodiment, the present invention is a data capture device comprising: a housing; a power source assembly within the housing; a load cell within the housing; and a weigh platter configured to be wholly supported by the load cell, the weigh platter further configured to support an object placed on the weigh platter for obtaining a weight of the object, the weigh platter having a power storage assembly, wherein the power source assembly is configured to supply electrical power to the power storage assembly resulting in stored electrical power, and wherein the power storage assembly is configured to deliver the stored electrical power to at least one electronic device within the weigh platter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed examples, and explain various principles and advantages of those embodiments.

FIG. 1 is an example indicia reader as used in an example setting in accordance with various embodiments of the present disclosure.

FIG. 2 is a perspective view of an example indicia reader for using weigh platters in accordance with various embodiments of the present invention.

FIG. 3 is a top-perspective view of the example indicia reader of FIG. 2 with the platter removed.

FIG. 4 is another example of a platter and its supporting structure in accordance with various embodiments of the present disclosure.

FIG. 5 is an example block diagram of an indicia reader in accordance with embodiment of the present disclosure.

FIG. 6 is a simplified cross-section of an indicia reader in accordance with embodiment of the present disclosure.

The apparatus and method components have been represented where appropriate by conventional symbols in the drawings, showing only those specific details that are pertinent to understanding the disclosed examples so as not to obscure the disclosure with details that will be readily apparent to those of ordinary skill in the art having the benefit of the description herein.

### DETAILED DESCRIPTION

In conventional weighing devices that have weigh platters (including devices like indicia readers like multi-plane and single-plane barcode readers), it is imperative that the weigh platter is supported by the load cell (which can include a support structure that is connected to the load cell) without interference from other objects and/or forces that can skew the measured weight. This creates difficulties in the ability to provide electrical power to devices that may be embedded in the platter. For example, using traditional methods of supplying electricity through wires may cause those wires to exert a pulling force on the platter, causing an inconsistent and/or inaccurate weight to be reported. Additionally, providing an electrical link by way of current-limited means like wireless power transfer provides a limited power budget, reducing the potential utilization of electrical components that are embedded in the platter. Accordingly, concepts and methodologies described herein address at least some of the foregoing concerns.

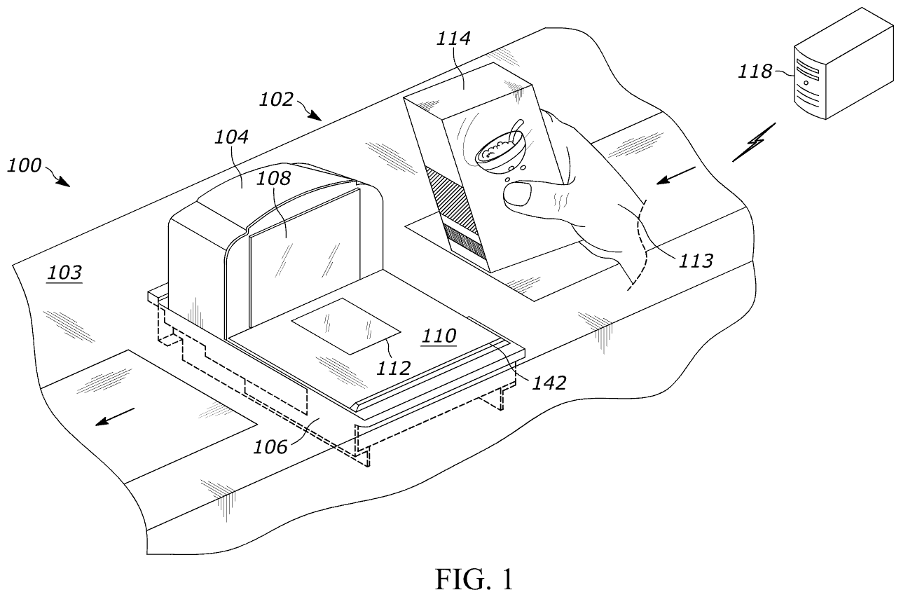

FIG. 1 illustrates a perspective view of an example bi-optic indicia reader 100 operable to provide power transfer to a weigh platter in accordance with embodiments of the present disclosure. As used herein, the term indicia should be understood to refer to any kind of visual marker that can be associated with an item. For example, indicia can be a 1D, 2D, or 3D barcode, a graphic, a logo, etc. Additionally, indicia may comprise encoded payload data as, for example, is the case with a 1D or 2D barcode where the barcode encodes a payload comprised of, for example, alphanumeric or special characters that may be formed into a string. In the illustrated example, the bi-optic indicia reader 100 is shown as part of a point-of-sale (POS) system arrangement 102 having the bi-optic indicia reader 100 positioned within a workstation counter 103. Generally, the indicia reader 100 includes an upper housing 104 (also referred to as an upper portion, upper housing portion, or tower portion) and a lower housing 106 (also referred to as a lower portion, lower housing portion, or platter portion). The upper housing 104 can be characterized by an optically transmissive window 108 positioned therein along a generally vertical plane and a horizontally extending field of view(s) which passes through the window 108. The lower housing 106 can be characterized by a weigh platter 110 that includes an optically transmissive window 112 positioned therein along a generally horizontal plane and a vertically extending field of view(s) which passes through the window 112. The weigh platter 110 is a part of a weigh platter assembly that generally includes the weigh platter 110 and a scale (or load cell) configured to measure the weight of an object placed the top surface of the weight platter 110. To avoid weight disturbances, the weigh platter is generally configured to rest wholly on the load cell (or portions thereof designed to support the weigh platter) such that the entire weight of the weigh platter along with any object placed therein is fully transferred to the load cell.

In operation, the indicia reader 100 can be used in multiple modes, including a mode where item-related data is passed to a point-of-sale (POS) host device based on the weight of an item involved in a transaction and a mode where item-related data is passed to a POS host device without regard for the weight of an item involved in a transaction.

In the latter mode, a user 113 generally passes an item 114 across a product scanning region of the indicia reader 100 in a swiping motion in some general direction, which in the illustrated example is right-to-left. A product scanning region can be generally viewed as a region that extends above the platter 110 and/or in front of the window 108 where indicia reader 100 is operable to capture image data of sufficient quality to perform imaging-based operations like decoding indicia that appears in the obtained image data. It should be appreciated that while items may be swiped past the indicia reader 100 in either direction, items may also be presented into the product scanning region by means other than swiping past the window(s). When the item 114 comes into the any of the fields of view of the reader, the indicia 116 on the item 114 is captured and decoded by the indicia reader 100, and corresponding data is transmitted to a communicatively coupled host 118 (commonly comprised of a point of sale (POS) terminal).

Indicia reader 100 can utilize a variety of imaging assemblies and optical components to achieve the desired field of view(s) FOV(s) over which image data can be captured and transmitted to a processing host (such as a decoder, processor, or ASIC that may be internal to the indicia reader 100) for decoding of indicia and further utilization of the decoded payload data. For example, an imaging assembly may include an image sensor (also referred to as an imager or imaging sensor) that can be, for example, a CCD or a CMOS imaging sensor and may either be a linear or a two-dimensional sensor. Linear image sensors generally include multiple photosensitive pixel elements aligned in a one-dimensional array. Two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through either of the generally horizontal or generally upright window(s). In instances where multiple imaging assemblies are used, each respective imager and imaging lens assembly pair is designed to operate together for capturing light scattered, reflected, or emitted from indicia as pixel data over a respective FOV. In other instances, a single imaging assembly may be used to generate a single primary FOV which may be split, divided, and/or folded to generate multiple FOVs. In such cases, data collected from various portions of the imaging sensor may be evaluated as if it was obtained by an individual imaging assembly/imaging sensor.

Returning to the various modes of use for the indicia reader 100, some items that are transacted for require a weight determination. These typically involve items like, for example, produce the price of which may be determined based on a cost-per-weight value. In such cases the type of item can often be determined in a number of ways. For instance, indicia attached to the produce may be scanned to help identify the item, the item may be recognized with the assistance of vision analysis, and/or by way of user input at the POS host device. However, in addition to identifying the item, to complete the transaction the item weight must be determined. This is done by placing the item on the top surface of the platter 110 (which in-turn is connected to a load cell of scale assembly) and reporting the determined weight after the weight has settled.

In certain instances, it may be desirable to embed one or more electronic components within the platter. In some examples, these components may be associated with an off-platter detection subsystem where sensing elements like optical sensors may be utilized around the periphery of the platter to help detect an item extending beyond the perimeter of the platter.

In some examples, the components embedded in the platter may be associated with a wake-up subsystem whereby sensing elements like beam-break components are incorporated into the platter to identify items coming into the product scanning region of the reader 100. Generally speaking, when items are not presented to the reader, the reader may enter a stand-by mode where at least one electrical component is operating at reduced functionality. Commonly this includes elements like the illumination subsystem which is either deactivated or is operating at reduced functionality, providing illumination for wake-up purposes and not for product scanning purposes. Once an item is detected within the product scanning region or within its vicinity, the electrical component that was operating at reduced functionality is transitioned to relatively increased functionality for item scanning purposes. In case of illumination, the illumination subsystem is instructed to provide sufficient illumination during image capture such that image data obtained during item presentation includes sufficient detail for indicia decoding purposes.

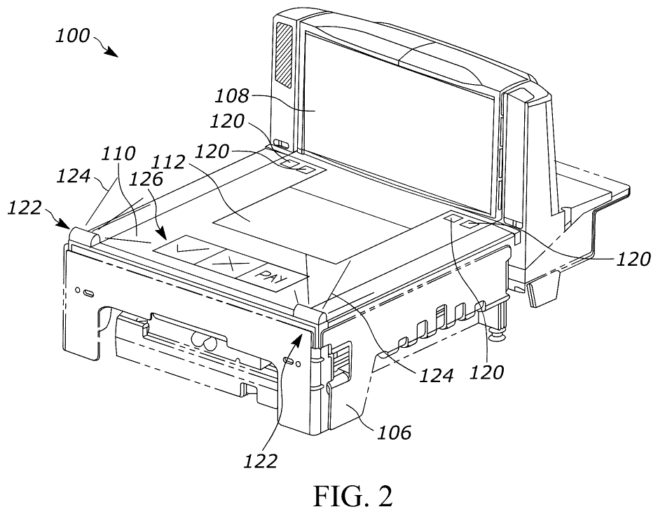

In some examples, the components embedded in the platter may be associated with an alert subsystem. The alert subsystem may be configured to provide any type of an alert (otherwise understood to be a signal that is discernable by an operator) and may include visual and/or auditory alerts. For example, referring to FIG. 2 which illustrates a perspective view of an example bi-optic indicia reader 100, the platter is shown as having signaling LEDs 120 which may be activated for any number of reasons. For example, they may be configured to blink a certain color in the event of a successful decode of an indicia and another color in the event of an unsuccessful decode. In other cases they may be configured to illuminate in the event of detection of an off-platter event. These are just examples of triggers and it should be understood that other triggers are within the scope of this disclosure. Also, it should be apparent that any number of LEDs may be provided and they may be positioned on any suitable place on the platter as necessary for a particular application. Furthermore, individual LED(s) may be configured to respond/activate to different triggering events.

In some examples, the components embedded in the platter may be associated with a vision-based data capture subsystem. Referring again to FIG. 2, shown at a distal end of the platter 110 are a pair of imaging assemblies 122. In the illustrated example, the optical components of these assemblies are housed underneath the raised portions and their respective fields of view (FOVs) 124 are directed towards the product scanning region and the upper portion of the bi-optic reader. The vision-based data capture subsystem can be employed for any number of applications, including waking up the reader when an object is observed entering the perimeter of the reader, identifying off-platter events, assisting with barcode decoding operations, and/or assisting with vision-based operations like product identification which may be particularly important for produce recognition or shrink detection.

In place of or in conjunction with vision-based data capture subsystem, in some examples, the components embedded in the platter may be associated with an auxiliary illumination subsystem. Referring to the example of FIG. 2, illumination components may be positioned in the same or near the location 122 and may have illumination fields that are same or similar to the FOVs 124. Such auxiliary illumination may be used to help illuminate objects for image capture by the vision-based data capture subsystem or it may be used for other purposes like waking up the reader.

In some examples, the components embedded in the platter may be associated with a radio-signal based data capture subsystem. In some cases, is may be desirable to embed a component like an RF antenna into the platter. This may be done in connection with implementing an RFID, NFC, Electronic Article Surveillance, or another RF-based data transmission system. The antenna may be embedded in the platter and may have a radiation pattern that covers at least some portion of the product scanning region. Items having an RF tag like an RFID tag brought within the volume of the product scanning region can then have the reader 100 communicate with the tag, potentially extracting identification data, writing data to the tag for transaction processing purposes, or for any other reason. Additionally, interaction with operator devices like mobile phones may be possible through interaction with NFC, allowing the user to easily convey loyalty card information to the reader 100.

In some examples, the components embedded in the platter may be associated with a user-interface (UI) subsystem. Referring to FIG. 2, shown therein is an example UI that is embedded in the platter 110. The UI may be in a form of a display, physical buttons, touch-sensitive buttons like capacitive touch buttons, or the like. Additionally, the UI may be used either for conveying information or for both conveying information and receiving the user input. Positioning the UI interface on a platter may be particularly advantageous as it places the actual interface components closer to the operator. Additionally, in instance where the reader is a single-plane reader or a scale, there may limited space for adequate UI features on structures outside the platter.

The foregoing and other components which may be embedded in the platter may have minimum current requirements and achieving constant flow of electricity with sufficient current may be problematic for the reasons described earlier in this disclosure. To address this, it has been recognized that devices like those which have been described above may not require constant operation. With such periodic operation, concepts described herein employ an energy storage assembly embedded within the platter which can supply adequate current to various platter-embedded subsystems on as needed basis and recharge during the times when a re-charge operation is permissible.

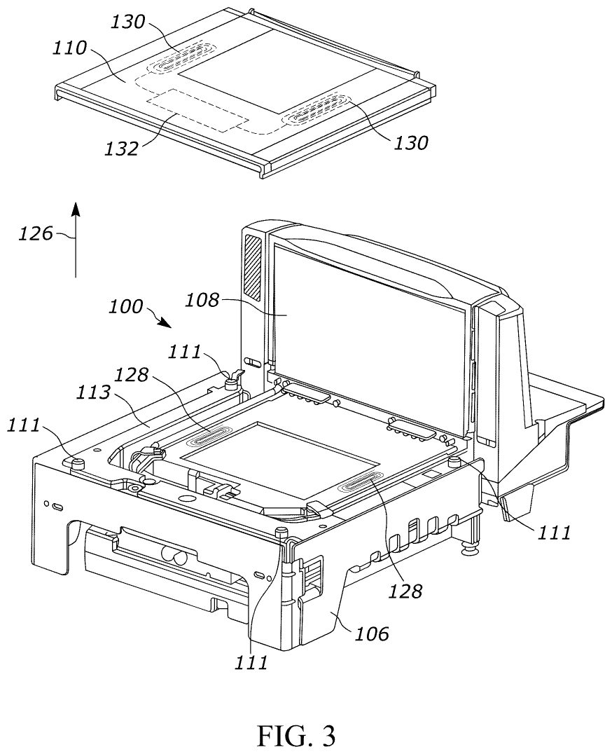

Referring to FIG. 3, shown therein is an example reader 100 with the platter 110 removed. In the illustrated embodiment, when in its lowered position, the platter 110 rests on protrusions 111 which are located on a support arm 113, which is in turn connected to a load cell. For the sake of brevity, references to “load cell” may refer to support structured like the support arm 113. It should be appreciated that in various embodiments the platter 110 is removable (typically in an upward direction 126) by the operator of the reader 100. This may be necessary to clean the platter, replace the platter in case of damage, and/or to clean the interior region of the reader underneath the platter. To enable the transfer of power to the from within the base of the reader 100, which is normally connected through a wire to a power source like a power receptacle, to the platter 110, the reader 100 may employ a power source assembly within the housing of the reader and a power storage assembly within the platter. In the illustrated example, wireless power transfer is used whereby the power source assembly includes a pair of inductive charging coils 128 and the platter includes a pair of complementary coils 130. When an alternating current is passed through the coils 128, each coil generates a magnetic field that, when the platter is positioned in its operational position on the reader 100, encompasses each respective coil 130. In response to being subjected to a magnetic field, a current is generated in each of the coils 130 which can then be transmitted to either an electrically consuming device that is embedded in the platter or to a power storage unit 132 embedded in the platter 110. The power storage unit 132 may take any form that can allow for the storage of electrical power, including a battery, capacitor, super capacitor, or any combination thereof. To receive power from the coils 130, the storage power unit 132 is connected to each coil via an electrical connection.

In some instances, a relatively substantial amount of charge current may be required. For this, the size of the coils may be adjusted accordingly. In other cases, each pair of corresponding coils (e.g., 128/130) may be nested such that, for example, coil 128 may be wound around a cavity into which a protrusion with the coil 130 could be inserted. Such configuration can increase the surface area over which charging may take place without expanding the charge components' footprint.

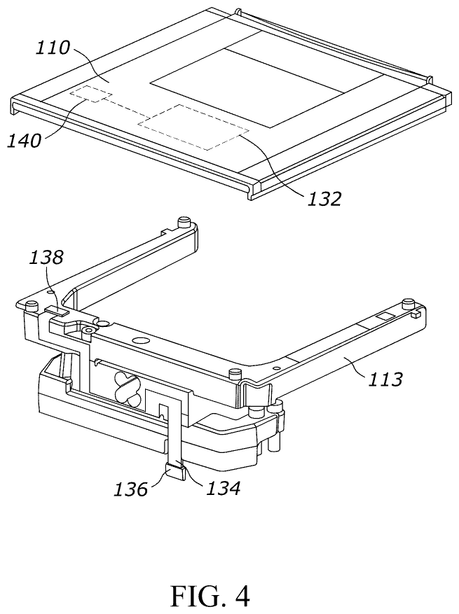

Another means of power transfer to the power storage unit 132 is illustrated in FIG. 4, which illustrates an example platter with the load cell and support arm of the reader 100. In this example, rather than relying on wireless power transfer, the power can be transmitted from the base of the reader 100 to the power storage unit 132 via a wired connection. For this, the wired connection includes a wire 134 and connector 136 that connects to a power source within the reader 100. It also includes a connector, on the opposite end, 138 that connects to a corresponding connector 140 on the platter 110. To allow for easy removal of the platter 110, connectors 138/140 may be complementary pogo-pin connector, spring connectors, magnetic connectors, etc. To avoid drag from the components of the wired connection, the wire 134 and the connectors 138/140 are fixedly positioned relative to the load cell (which includes the platter support arm) and the platter 110. Once an electrical connection is established between the connectors 138/140, electrical charge can be transmitted to the power storage unit 132 via an electrical connection from the connector 140 to the power storage unit 132.

In a preferred embodiment, the weigh platter has a clearance of at least 2 mm of downward travel relative to the housing of the indicia reader.

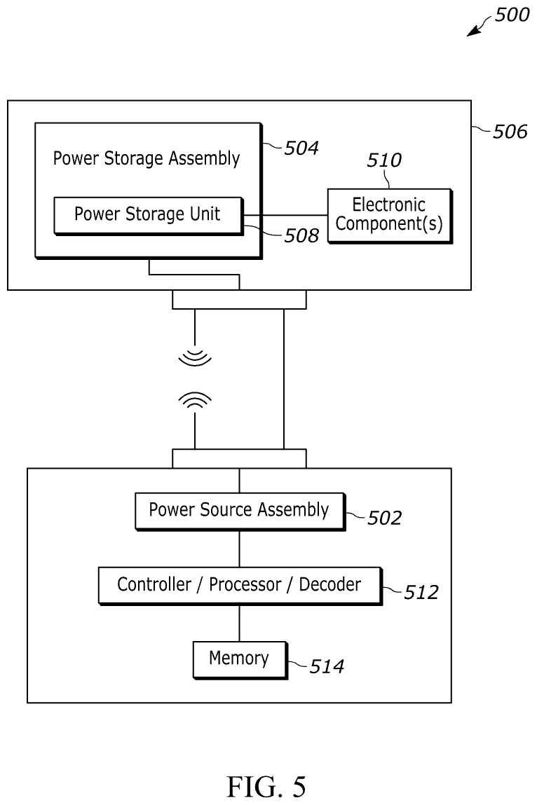

A more general block diagram of an example reader in accordance with embodiments of the invention is provided in FIG. 5. As shown therein, the reader 500 includes a power source assembly 502, which is electrically coupled to the power storage assembly 504 of the platter 506. The power storage assembly 504 includes a power storage unit 508 which is connected to one of more electrical components 510 embedded in the platter 506. To enable selective power transfer, the reader 500 may include a controller/processor 512 that may control at least some aspects of the power transfer from the power source assembly to the power storage assembly. This controller may be in communication with a memory 514 that can store instructions that, when executed by the controller/processor may cause the charging components to operate as needed.

Once a sufficient charge is stored in the power storage unit 508, the power storage unit can dispense the electrical energy to any appropriate electrical device that is embedded in the platter 506 as required by that device.

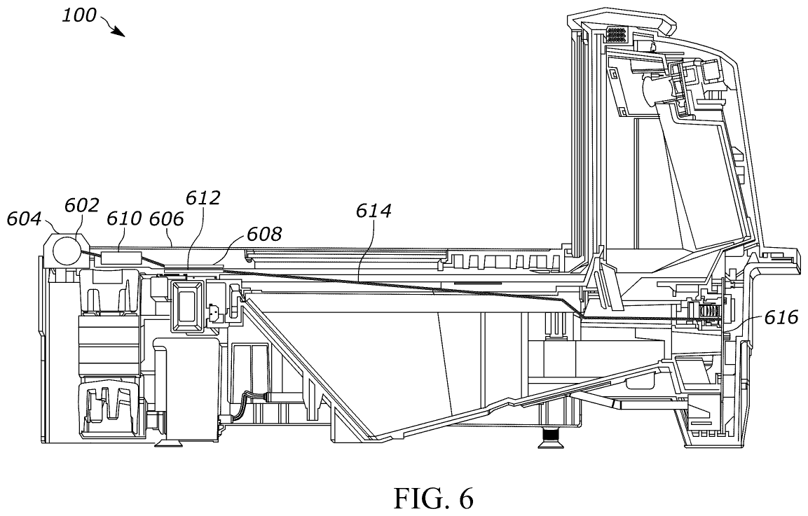

In some embodiments, the power storage unit may be a relatively flat unit embedded in the distal portion of the platter as illustrated in FIGS. 3 and 4. In other embodiments, the platter may be provided with a raised ridge portion 142 (see FIG. 1) which can extend along a distal side of the platter. This raised portion extends above the generally flat surface of the rest of the platter 110 and under normal circumstances can provide a ledge for placement of produce. Referring to FIG. 6, which illustrates an example simplified cross-section view of a bi-optic reader 100, the example positions of the power storage unit(s) may be seen therein. Namely, a cylindrically shaped power storage unit 602 is shown as being positioned within the ridge area 604 located at the distal end of the platter 606. While the power storage unit 602 can be connected directly to the receiving coil 608 of the power storage assembly, it can further be connected thereto via intervening electronic components which, without limitation, can include the components mentioned earlier and/or through another power storage unit 610. As explained previously, in the example of wireless power transfer, the receiving coil 608 receives power from charge coil 612 of the power source assembly, which may be electrically coupled via a wired connection 614 to a powered source (like a circuit board 616) within the housing of the reader.

In some instances, the presence of a magnetic field emitted by the charge coil may interfere with the weighing operations of the reader. To address this, the reader may be configured to selectively charge the power storage assembly where the operation is at least partially controlled by the controller/processor of the reader. In particular, to avoid interfering with weighing operations, the controller may be configured to activate the power source assembly to supply the electrical power to the power storage assembly by default or when there is a zero weight detected on the scale (e.g., no items are being weighted). However, once a positive weight is sensed by the load cell, the power source may be deactivated from supplying the electrical power to the power storage assembly. In this way, when an item is weighed, the charging operations are deactivated and there is no interference from magnetic field(s) which may be present when power transfer is occurring. It should be appreciated that while in some embodiments a positive weight can be understood to mean any non-zero weight, in some other embodiments a positive weight can be understood to mean a weight exceeding a predetermined threshold like, for example, 0.5 oz, 1 oz, 2 oz, etc.

Another example of selective charging can be based on whether or not the reader is in the awake or the stand-by state. In particular, the controller may be configured to enable charging operations when the reader is in stand-by mode and disable those operations when the reader wakes up and enters the reading mode. This could be particularly useful in cases where RF-based data capture operations are need to be performed during product scanning. For example, reading of RFID tags on products presented in the product scanning region may be adversely affected by the charging operations. In such instances, disabling the charging operations and thus eliminating electromagnetic interference is desirable.

It should be appreciated what while the examples above describe the transfer of power from the base of the reader to the platter and specifically to the power storage assembly, besides power it is conceivable that electronic data can also be exchanged between the platter and the rest of the reader through the same transfer means. For example, in case of wireless charging it is within the scope of the present disclosure that besides power, information can also be transmitted between the coils. Similarly, data can be transmitted through a wired connected between the reader base and the platter. This data can be used as, for example, control signals for the electronic components embedded in the platter and/or to, for example, transmit data gathered by the electronic devices embedded in the platter to the reader controller/processor for further processing.

It should further be appreciated that while the examples above have been described with the power source assembly positioned within the base of the reader and the power storage assembly positioned within the flat portion of the platter, this should not be seen as limiting. In some examples the platter may have additional structures like, for example, an upright portion that extends from the end proximal the tower. This can be implemented to help avoid having produce or other items that are being weighed from resting on the tower portion. In such a configuration, concepts described herein can also apply whereby any of the components of the power source assembly and the power storage assembly may be positioned within the upright portion of the platter and a corresponding position on the tower. For instance, both the tower portion and the upright portion of the platter may have one or more pairs of corresponding charging coils to enable power transfer as described herein.

Furthermore, concepts described herein may also apply to configuration where no scale is used. In these configurations the platter is still a removable platter which can be cleaned and/or replaced, but rather than resting on a load cell (or portions thereof like the load cell arm), the platter rests on the stationary frame of the reader.

Additionally, the concepts described herein are also applicable to single slot scanners with platters and/or dedicated scale devices without other data capture assemblies (e.g., a scale used in a deli section of a venue).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An indicia reader comprising:
a housing having a lower housing portion with an upper surface facing a product scanning region and an upper housing portion extending above the lower housing portion;
a power source assembly positioned at least partially within the housing;
a load cell; and
a weigh platter configured to be supported by the load cell, the weigh platter further configured to support an object placed on the weigh platter for obtaining a weight of the object, the weigh platter having a power storage assembly,
wherein the power source assembly is configured to supply electrical power to the power storage assembly resulting in stored electrical power, and
wherein the power storage assembly is configured to deliver the stored electrical power to at least one electronic device within the weigh platter.

2. The indicia reader of claim 1, wherein the power source assembly is configured to supply the electrical power to the power storage assembly via a wireless power transfer.

3. The indicia reader of claim 2, wherein the power source assembly includes a first inductive coil configured to generate a magnetic field in response to a first current being supplied to the first inductive coil,
wherein the power storage assembly includes a second inductive coil configured to generate a second current responsive to being with the magnetic field, and
wherein the second current is converted to the stored electrical power in a power storage unit of a power storage assembly.

4. The indicia reader of claim 3, wherein one of the first inductive coil or the second inductive coil is nested within another one of the first inductive coil or the second inductive coil.

5. The indicia reader of claim 1, further comprising a controller communicatively coupled to the load cell and the power source assembly, wherein the controller is configured to activate the power source assembly to supply the electrical power to the power storage assembly, and responsive to detecting a positive weight sensed by the load cell, deactivate the power source from supplying the electrical power to the power storage assembly.

6. The indicia reader of claim 1, further comprising a controller communicatively coupled to the load cell and the power source assembly, wherein the controller is configured to activate the power source assembly to supply the electrical power to the power storage assembly, and responsive to detecting a wakeup signal from a wakeup subsystem, deactivate the power source from supplying the electrical power to the power storage assembly.

7. The indicia reader of claim 1, wherein the weigh platter includes a first lateral side, a second lateral side parallel to the first lateral side, a first transverse side proximal the upper housing portion, and a second transverse side distal the upper housing portion,
wherein the second transverse side includes a ridge portion extending above the upper surface of the weigh platter, and
wherein the power storage assembly includes a power storage unit located at least partially within the ridge portion.

8. The indicia reader of claim 1, wherein the weigh platter includes a first lateral side, a second lateral side parallel to the first lateral side, a first transverse side proximal the upper housing portion, and a second transverse side distal the upper housing portion,
wherein the weigh platter further includes an upright portion extending in an upward direction at the first transverse side, the upright portion of the weigh platter extending along a side of the upper housing, and
wherein the power storage assembly includes a power storage unit located at least partially within the upright portion of the weigh platter.

9. The indicia reader of claim 1, wherein the at least one electronic device within the weigh platter is associated with at least one of an off-platter detection subsystem, a wake-up subsystem, an alert subsystem, a vision-based data capture subsystem, a radio-signal based data capture subsystem, or a user-interface subsystem.

10. The indicia reader of claim 1, wherein the weigh platter has a clearance of at least 2 mm of downward travel relative to the housing of the indicia reader.

11. The indicia reader of claim 1, wherein the weigh platter is removable from the indicia reader by an operator of the indicia reader.

12. A data capture device comprising:
a housing;
a power source assembly within the housing;
a load cell within the housing; and
a weigh platter configured to be wholly supported by the load cell, the weigh platter further configured to support an object placed on the weigh platter for obtaining a weight of the object, the weigh platter having a power storage assembly,
wherein the power source assembly is configured to supply electrical power to the power storage assembly resulting in stored electrical power, and
wherein the power storage assembly is configured to deliver the stored electrical power to at least one electronic device within the weigh platter.

13. The data capture device of claim 12, wherein the power source assembly is configured to supply the electrical power to the power storage assembly via a wireless power transfer.

14. The data capture device of claim 13, wherein the power source assembly includes a first inductive coil configured to generate a magnetic field in response to a first current being supplied to the first inductive coil,
wherein the power storage assembly includes a second inductive coil configured to generate a second current responsive to being with the magnetic field, and
wherein the second current is converted to the stored electrical power in a power storage unit of a power storage assembly.

15. The data capture device of claim 14, wherein one of the first inductive coil or the second inductive coil is nested within another one of the first inductive coil or the second inductive coil.

16. The data capture device of claim 12, further comprising a controller communicatively coupled to the load cell and the power source assembly, wherein the controller is configured to activate the power source assembly to supply the electrical power to the power storage assembly, and responsive to detecting a positive weight sensed by the load cell, deactivate the power source from supplying the electrical power to the power storage assembly.

17. The data capture device of claim 12, further comprising a controller communicatively coupled to the load cell and the power source assembly, wherein the controller is configured to activate the power source assembly to supply the electrical power to the power storage assembly, and responsive to detecting a wakeup signal from a wakeup subsystem, deactivate the power source from supplying the electrical power to the power storage assembly.

18. The data capture device of claim 12, wherein the weigh platter includes a first lateral side, a second lateral side parallel to the first lateral side, a first transverse side, and a second transverse side,
wherein at least one of the first lateral side, the second lateral side, the first transverse side, or the second transverse side includes a ridge portion extending above a substantially flat surface of the weigh platter, and
wherein the power storage assembly includes a power storage unit located at least partially within the ridge portion.

19. The data capture device of claim 12, wherein the at least one electronic device within the weigh platter is associated with at least one of an off-platter detection subsystem, a wake-up subsystem, an alert subsystem, a vision-based data capture subsystem, or a radio-signal based data capture subsystem.

20. The data capture device of claim 12, further comprising:
an imaging assembly operable to capture image data having an indicia captured therein; and
a decoding module configured to analyze the image data to decode the indicia and to provide a decoded payload to a host.

21. The data capture device of claim 12, wherein the weigh platter has a clearance of at least 2 mm of downward travel relative to the housing.

22. The data capture device of claim 12, wherein the weigh platter is removable off the load cell by an operator of the data capture device.
